(19) United States
(12) Patent Application Publication
(10) Pub. No.: US 2026/0289847 A1
(43) Pub. Date: Sep. 24, 2026

(54) VIDEO GENERATION USING FRAME PROMPTING

(71) Applicant: GOOGLE LLC, Mountain View, CA (US)

(72) Inventor: Anthony Lui, Mountain View, CA (US)

(21) Appl. No.: 19/085,665

(22) Filed: Mar. 20, 2025

(51) Int. Cl. G06T 11/60; G06N 3/0475

(52) U.S. Cl. CPC G06T 11/60; G06N 3/0475

(57) ABSTRACT

A method for generating a new video from a source video includes obtaining a source video, identifying video segments, in the source video, that each include a respective plurality of consecutive frames, obtaining frame subsets each corresponding to a different one of the video segments, generating, by a generative artificial intelligence (AI) model, new video segments each corresponding to a different one of the frame subsets by providing the frame subsets as inputs to the generative AI model, and generating a new video that includes the plurality of new video segments.

### FIELD OF TECHNOLOGY

The present disclosure relates to digital video generation techniques and, more particularly, to techniques for using generative artificial intelligence to generate a new video from a source video.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

In some scenarios, it can be desirable to create a new video from a source video, creatively changing the content of the source video while maintaining certain qualities of the source video. In digital advertising, for example, content providers (e.g., advertisers) may wish to provide a wide array of similarly themed video advertisements in order to provide variety to viewers, and/or to experiment with different variations on an advertisement to see which variations perform the best (e.g., have the highest click-through or conversion rates), and so on. Generative artificial intelligence (AI) models, such as multimodal large language models (MLLMs), have gained traction as a useful tool for video generation, including the aforementioned modification of existing videos. However, generative AI models tend to suffer from various drawbacks. For example, even when starting from a suitable source video, such models may produce new video content that strays far from the desired context of the source video and/or contains bizarre or nonsensical content.

### SUMMARY

In the disclosed techniques, a system generates a new video based on a source video. As the terms are used herein, and unless the context of use clearly indicates otherwise, generating or creating a “new” video based on or from a source video may also be referred to as “editing” or “transforming” the source video, and vice versa, regardless of how closely the new video aligns with (e.g., appears similar to) the source video.

The disclosed systems and methods use “frame prompting” techniques to generate the new video from the source video. In particular, the techniques identify video segments or “shots” within the source video and, within each such video segment, obtain (e.g., select) a particular subset of one or more, but not all, frames. The techniques then input the frame subset for each of multiple such video segments into a generative artificial intelligence (AI) model (e.g., apply the frame subsets as successive prompts to a multimodal large language model (MLLM)) in order to generate a new video segment corresponding to that frame subset. The techniques use the new video segments to generate the new video, e.g., by assembling a combination of source video segments and new video segments.

The disclosed techniques can mitigate problems with current techniques that generate new video content from source video content using generative AI models. By tethering the generation of new video segments to frame subsets of multiple video segments across the span of the source video (e.g., rather than using only an initial frame of the source video to generate a new video), the techniques can produce a new video that is more consistently contextualized by the source video (e.g., stays more true, throughout the new video, to the style and/or content bounds of the source video), and is less likely to include nonsensical or other undesired content. At the same time, the use of only a portion of the source video segment (i.e., only the frame subset, such as a single “seed” frame) to generate a new video segment allows room for substantial creativity and variability in the new video relative to the source video.

In a digital advertising context, for example, the disclosed techniques can better ensure that certain aspects of the source video (e.g., a general style and/or theme that is known to provide good performance metrics such as click-through or conversion rates, or is desired for other reasons such as brand safety, etc.) are maintained, while also leaving room for generative AI to potentially improve upon performance and/or quality metrics by generating substantially different, creative variants.

Other advantages will also become apparent to one of ordinary skill in the art upon reading this disclosure and viewing the corresponding drawings.

### BRIEF DESCRIPTION OF THE DRAWINGS

FIG. 1 is a block diagram of an example system in which one or more video generation techniques of the present disclosure can be implemented.

FIG. 2 depicts an example process for generating a new video from a source video, which may be implemented by the computing system of FIG. 1.

FIG. 3 depicts example video processing operations that may occur within the process of FIG. 2.

FIG. 4 is a flow diagram of an example method for generating a new video from a source video.

### DETAILED DESCRIPTION OF THE DRAWINGS

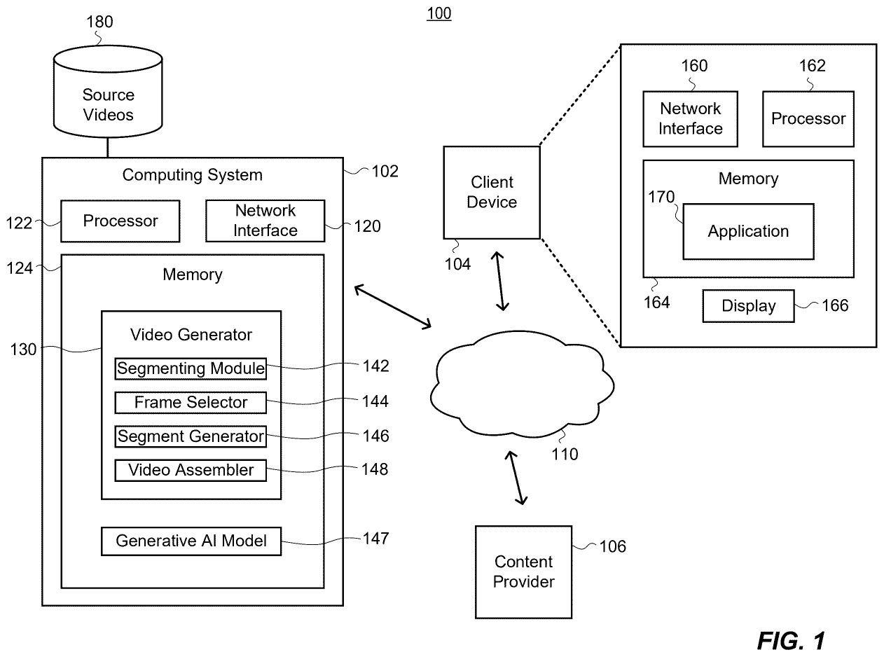

FIG. 1 is a block diagram of an example system 100 in which the disclosed techniques for video generation can be implemented. The example system 100 includes a computing system 102, a client device 104, a content provider 106 (e.g., a server of a content provider), and a network 110. The computing system 102 is remote from the client device 104 and content provider 106, and is communicatively coupled to the client device 104 and content provider 106 via the network 110. In some implementations, however, the system 100 does not include client device 104 and/or content provider 106.

The network 110 may be a single communication network (e.g., the Internet), and in some implementations also includes one or more additional networks. As just one example, the network 110 may include a cellular network, the Internet, and a server-side local area network (LAN). While FIG. 1 shows only a single client device 104 and single content provider 106, it is understood that the computing system 102 may also be in communication with a number (e.g., thousands or millions) of other client devices that are generally similar to the client device 104, and/or in communication with a number (e.g., hundreds or thousands) of other content providers that are generally similar to content provider 106.

Generally, computing system 102 can perform video generation/transformation services (e.g., for providers such as content provider 106). In a digital advertising context, for example, computing system 102 may use one or more existing videos from content providers such as content provider 106 as source videos to generate new videos that the content provider can use in future digital advertising. In one such example, the new/additional videos can be used to provide a greater diversity of videos/advertisements, and/or to provide better performing videos/advertisements (e.g., as measured based on impression rate, click-through rate, conversion rate, etc.).

As another example, computing system 102 may generate new videos that are intended to facilitate viewer understanding (e.g., videos for instructional materials), where performance is measured by way of determining what proportion of viewers take the correct actions upon viewing the videos. Other contexts are also possible. For ease and consistency of explanation, however, this disclosure primarily uses examples that relate to a digital advertising implementation/context.

The client device 104 is generally configured to access information resources (e.g., web pages and/or user interfaces of mobile applications or other applications) that can present the videos generated by computing system 102. For example, computing system 102 may generate digital video advertisements and then serve (or another computing system may then serve) the digital advertisements to users of client device 104 and/or other similar client devices using suitable techniques, such as conducting auctions (e.g., auctions based on keyword bids by advertisers, relevancy metrics, etc.). The digital advertisements may be served in slots of web pages visited by the users, and/or slots of application user interfaces displayed to the users, etc.

The content provider 106 generally may commission or request that computing system 102 generate one or more videos, and/or may provide the source video(s) upon which the video generation is based. For example, content provider 106 may be a digital advertiser who provides a digital advertisement video for each of a number of offered products or services, as part of one or more advertising campaigns owned or managed by content provider 106.

The computing system 102 includes a network interface 120, a processor 122, and memory 124. The network interface 120 includes hardware, firmware, and/or software configured to enable the computing system 102 to exchange electronic data with the client device 104 and other, similar client devices (and possibly content provider 106, etc.) via the network 110. For example, the network interface 120 may include a wired or wireless router and a modem. The processor 122 may be a single processor (e.g., a central processing unit (CPU)), or may include multiple processors (e.g., multiple CPUs, or one or more CPUs and one or more graphics processing units (GPUs)). Computing system 102 may be a single computing device (e.g., server) at a single location, or may include multiple, coordinating computing devices that are either co-located or remotely distributed.

The memory 124 is a computer-readable, non-transitory storage medium, unit, or device, or a collection of such media/units/devices, and may include persistent and/or non-persistent memory components. The memory 124 stores instructions executable by processor 122 to perform various operations, including the instructions of various software applications and the data generated and/or used by such applications. In the example system 100 of FIG. 1, memory 124 stores the instructions of a video generator 130, which includes a segmenting module 142, a frame selector 144, a segment generator 146, and a video assembler 148. The operations of these components are discussed in greater detail below.

Generally, however, segmenting module 142 is configured to identify discrete video segments within a source video, frame selector 144 is configured to obtain (e.g., select) specific subsets of one or more frames within a given video segment, segment generator 146 is configured to use a generative artificial intelligence (AI) model 147 to generate new video segments from the obtained frame subsets, and video assembler 148 is configured to assemble the new video segments (possibly with one or more source video segments and/or other video segments) into a new video. As the terms are used herein, a “segment” or “video segment” refers to a particular set of consecutive frames of a video, which may be with or without corresponding audio content.

In the depicted implementation, generative AI model 147 is also stored in memory 124. In other implementations, generative AI model 147 is not stored in memory 124, and is instead stored in a remote server or other computing device or system. For example, generative AI model 147 may be remotely accessed (e.g., as a cloud service) by segment generator 146 via network 110. In some implementations, generative AI model 147 is a multimodal large language model (MLLM). In other implementations, generative AI model 147 is a diffusion model, or any other suitable model capable of generating frames of a video segment from an input set of one or more frames. In some implementations, generative AI model 147 is an MLLM that accepts as input a prompt that includes a set of one or more “seed” frames along with a text portion, with the text portion instructing the MLLM to generate a video segment according to one or more criteria, considerations, preferences, limitations, etc.

It is understood that, in some implementations, memory 124 may include one or more additional components not shown in FIG. 1, such as components that facilitate serving videos (e.g., pre-roll or mid-roll advertisements) to users of devices such as client device 104.

The client device 104 may be or include any stationary, mobile, or portable computing device with wired and/or wireless communication capability (e.g., a smartphone, a tablet computer, a laptop computer, a desktop computer, a smart wearable device such as smart glasses or a smart watch, a vehicle head unit computer, etc.). In the example implementation of FIG. 1, client device 104 includes a network interface 160, a processor 162, memory 164, and a display 166. The processor 162 may be a single processor, or may include multiple processors.

Memory 164 includes one or more computer-readable, non-transitory storage media, units, or devices, which may include persistent and/or non-persistent memory components. Memory 164 stores instructions that are executable by processor 162 to perform various operations, including the instructions of various software applications and the data generated and/or used by such applications.

In the example system 100 of FIG. 1, memory 164 stores at least an application 170. Generally, application 170 is executed by processor 162 to provide one or more user interfaces via display 166, where the user interface(s) enable a user to access information resources that can include videos generated by computing system 102. For example, application 170 may be a web browser application, and videos generated by video generator 130 may be included in content slots of web pages visited by the user and presented on display 166. As a more specific example, the videos may be digital advertisements that are generated by video generator 130, and then selected and provided to client device 104 by computing system 102 (or by another computing system) for insertion in the content slots. In other implementations, application 170 is a dedicated application (e.g., a “mobile app”), and videos generated by video generator 130 are included in content slots or video players of user interfaces that are presented by the application 170 on display 166. The computing system 102 may provide/transmit the videos to client devices such as client device 104 as streaming videos (e.g., in implementations where application 170 is a YouTube® mobile application, or is a web browser that the user of client device 104 is using to access the YouTube® website).

The display 166 includes hardware, firmware, and/or software configured to enable a user to view visual outputs of the client device 104, and may use any suitable display technology (e.g., LED, OLED, LCD, etc.). In some implementations, the display 166 is incorporated in a touchscreen having both display and manual input capabilities. Moreover, in some implementations where the client device 104 is a wearable device, the display 166 is a transparent viewing component (e.g., lenses of smart glasses) with integrated electronic components. For example, the display 166 may include micro-LED or OLED electronics embedded in lenses of smart glasses. While not shown in FIG. 1, client device 104 can also include one or more audio output devices or components such as one or more speakers (e.g., for presenting audio that accompanies videos provided by computing system 102 or another computing system).

The network interface 160 includes hardware, firmware, and/or software configured to enable the client device 104 to exchange electronic data with the computing system 102 via the network 110. For example, the network interface 160 may include a cellular communication transceiver, a WiFi transceiver, and/or transceivers for one or more other wired and/or wireless communication technologies.

While FIG. 1 shows client device 104 as a single component communicating directly (i.e., via network 110) with the computing system 102, in some implementations the subcomponents of client device 104 shown in FIG. 1 are instead divided among two or more user-side devices. As just one example, a pair of smart glasses may include the processor 162, the memory 164, and the display 166, while a smartphone may include another processing unit, another memory, another display, and the network interface 160. The smart glasses may then communicate as needed with the smartphone (e.g., via Bluetooth) to enable the operations described herein.

A database 180 stores source videos upon which video generator 130 can operate. The database 180 may be stored in one or more memories, and as one or more component databases. In some implementations, database 180 is stored in memory 124. Database 180 may store source videos received from content provider 106 and similar other content providers, for example.

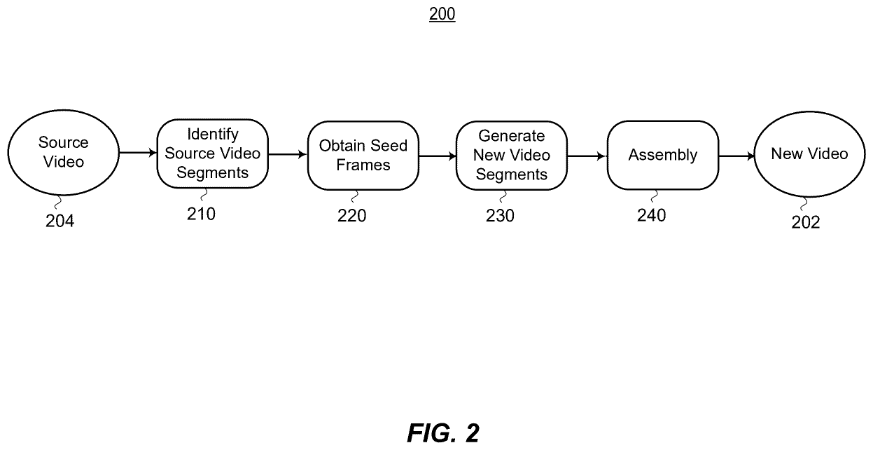

Operation of the computing system 102 (and in particular, video generator 130) will now be described in connection with the example process 200 of FIG. 2. The process 200 generates a new video 202 from a source video 204 (e.g., stored in database 180), and may be performed in part or in its entirety by video generator 130 (e.g., as executed by processor 122 when implementing instructions stored in memory 124).

At stage 210, the process 200 (e.g., segmenting module 142) identifies multiple video segments (i.e., sets of consecutive frame sequences) within source video 204. The identified video segments may or may not collectively cover the entire span of source video 204, and may or may not be consecutive segments of the source video 204, depending on the implementation and/or scenario. Stage 210 may include identifying the source video segments based on metadata (e.g., existing timestamps that delineate the video segments of source video 204) or may include identifying the source video segments by applying rules, algorithms, and/or machine learning techniques, etc., depending on the implementation. In some implementations, for example, stage 210 includes segmenting source video 204 into segments of predetermined length (e.g., 1 second, 2 seconds, 10 seconds, etc.), based on predefined or user-entered parameters. In another example implementation, stage 210 includes using a machine learning model (e.g., stored in memory 124, or remotely accessed) to determine times at which to delineate starting and/or stopping points of each segment. For example, such a machine learning model may be a convolutional neural network (CNN), a recurrent neural network (RNN) (e.g., a long short-term memory (LSTM) model), or another suitable model trained to detect transitions between scenes based on video and/or audio content of source video 204.

At stage 220, the process 200 (e.g., frame selector 144) obtains “seed” frames from the video segments identified at stage 210. In particular, stage 220 includes, for each segment of some or all of the source video segments identified at stage 210, obtaining a subset of frames from the full set of frames contained in that segment. The subset may consist of only a single frame or may include multiple (but not all) frames of the segment, depending on the implementation and/or scenario. In some implementations, stage 220 includes, for each identified video segment, receiving a user selection of a particular frame subset (e.g., a specific frame) within that video segment. In other implementations, stage 220 includes selecting the seed frames by applying rules, algorithms, and/or machine learning techniques, etc., depending on the implementation. In some implementations, for example, stage 220 includes selecting an initial frame (or a middle frame, etc.) of each identified video segment. In another example implementation, stage 220 includes using a machine learning model (e.g., stored in memory 124, or remotely accessed) to select a frame subset. For example, such a machine learning model may be a CNN, an RNN (e.g., an LSTM model), or other suitable model trained to predict a quality metric for each frame or frame subset, with “quality” being a subjective indicator of how interesting content is, or the aesthetic value of content, etc. In one such implementation, the machine learning model is trained using supervised learning techniques that employ user-provided scores, ratings, or other labels.

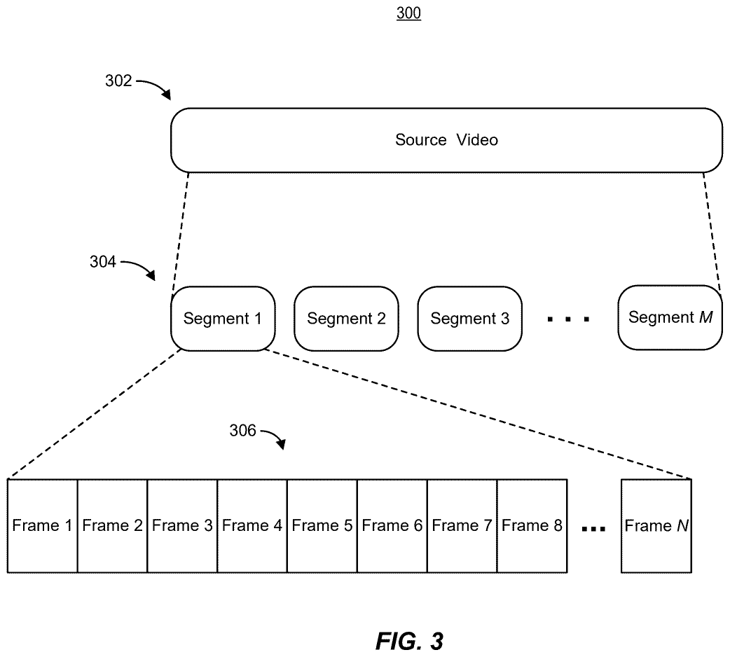

The operations of stages 210 and 220 may be understood with reference to FIG. 3, which depicts an example arrangement 300 of a source video 302. Source video 302 may be, for example, source video 204 of FIG. 2, the M consecutive segments 304 may be the video segments identified at stage 210, and the N consecutive frames 306 may be the frames of a first segment of the M segments, with the frame subset (at least one frame but not all M frames) being obtained from the M segments at stage 220. In various implementations and/or scenarios, the segments identified at stage 220 do not span the entire source video 302, and/or frame selector 144 only obtains frame subsets for certain segments identified at stage 210 (e.g., only Segment 2 and Segment M in FIG. 3, etc.). Other variations are also possible.

Returning now to FIG. 2, at stage 230, the process 200 (e.g., segment generator 146) generates a new video segment for each of some or all of the seed frame subsets obtained at stage 220. In particular, segment generator 146 applies the frame subset (e.g., single frame) for a given video segment as an input to generative AI model 147. In some implementations where the generative AI model 147 is an MLLM (e.g., a transformer-based MLLM), segment generator 146 uses a prompt template with text to generate a prompt for the MLLM. For example, segment generator 146 may apply, as input to the MLLM, both a selected frame for a given video segment and the following text:
You are highly experienced in the field of generating creatives for online advertisers. Given the following frame, create a two second dynamic video segment that generally maintains the look and feel of the frame.
<link to frame image>

Segment generator 146 may reapply the same template for each of the seed frame subsets obtained at stage 220. In some implementations, the prompt template instructs the MLLM to maintain/precisely replicate the seed frame(s) in the new video segment. In other implementations, the prompt template instructs the MLLM to not precisely replicate the seed frame(s) in the new video segment, or leaves the decision to the MLLM.

At stage 240, the process 200 (e.g., video assembler 148) uses the new video segments generated by generative AI model 147 at stage 230 (possibly after some post-processing) to form new video 202. In some implementations, stage 240 includes replacing some or all video segments of the source video with the corresponding new video segments that were generated based on seed frame(s) from those source video segments. In other implementations, stage 240 only replaces a subset of the source video segments (e.g., only source video segments predicted to have low quality or low performance by a machine learning model, etc.). In some implementations, the original ordering of video segments (i.e., of source video segments relative to each other, and relative to the new video segments that correspond to particular source video segments) is maintained at stage 240. In other implementations, the order may be altered.

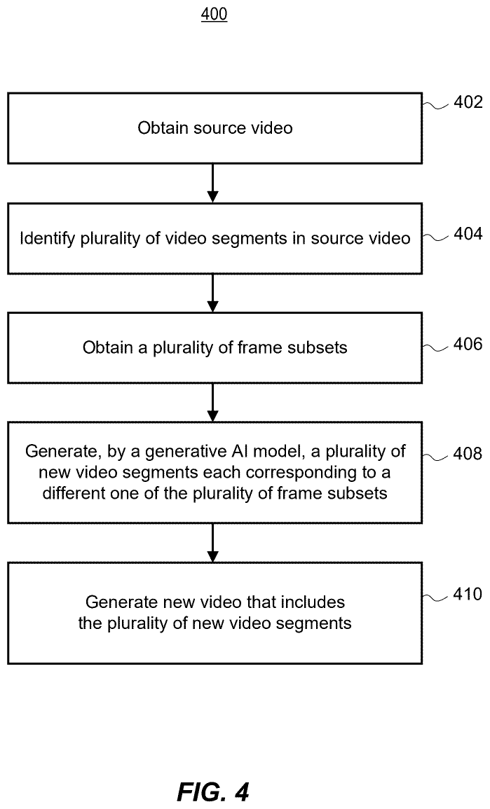

FIG. 4 is a flow diagram of an example method 400 for generating a new video from a source video. The method 400 may be implemented by the computing system 102 (e.g., video generator 130, as executed by processor 122) of FIG. 1, for example. The process 200 of FIG. 2 is an example implementation of the method 400.

At block 402, a source video is obtained. For example, block 402 may include receiving the source video from content provider 106 via network 110, or retrieving the source video from database 180.

At block 404, a plurality of video segments in the source video is identified. Each video segment of the plurality of video segments includes a respective plurality of consecutive frames (e.g., as shown in FIG. 3). Block 404 may be similar to stage 210 of FIG. 2, for example.

At block 406, a plurality of frame subsets is obtained. Each frame subset of the plurality of frame subsets consists of a subset of frames (i.e., at least one frame, but not all frames) within a different one of the plurality of video segments identified at block 404. It is understood that block 404 may, in some implementations and/or scenarios, include identifying additional source video segments for which no frame subsets are obtained at block 406 (e.g., video generator 130 may apply certain criteria to determine which of the source identified video segments are suitable to be used for obtaining seed frames). Block 406 may be similar to stage 220 of FIG. 2, for example.

At block 408, a plurality of new video segments, each corresponding to a different one of the plurality of frame subsets, is generated by a generative AI model (e.g., generative AI model 147). Block 408 includes providing the plurality of frame subsets as inputs to the generative AI model (e.g., as successive prompts to an MLLM). Block 408 may be similar to stage 230 of FIG. 2, for example.

At block 410, the new video is generated in such a manner that the new video includes the plurality of new video segments. It is understood that block 408 may, in some implementations and/or scenarios, include generating additional new video segments that are not included in the new video (e.g., new video segments that fail to meet some criteria/threshold and are therefore discarded or ignored before block 410). Block 410 may be similar to stage 240 of FIG. 2, for example.

In other implementations, the method 400 may include more or fewer blocks, and/or certain blocks may occur in an order other than what is shown in FIG. 4.

As is apparent from the above description, some of the techniques disclosed herein use artificial intelligence to generate high-performing videos. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and finetuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

In some implementations, the computing system 102 may use one or more of the machine learning models or techniques noted above to perform any one or more of the operations discussed herein in connection with machine learning. For example, the computing system 102 may use one or more such machine learning techniques to identify video segments, to select a frame subset from a particular video segment, to generate a new video segment based on a particular frame subset, and so on.

Although the foregoing text sets forth a detailed description of numerous different aspects and implementations of the invention, it should be understood that the scope of the patent is defined by the words of the claims set forth at the end of this patent. The detailed description is to be construed as exemplary only and does not describe every possible implementation because describing every possible implementation would be impractical, if not impossible. Numerous alternative implementations could be implemented, using either current technology or technology developed after the filing date of this patent, which would still fall within the scope of the claims.

The following additional considerations apply to the foregoing discussion and the appended claims. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first set of one or more processors (e.g., in a first computing device) generates X and a distinct, second set of one or more processors (e.g., in a different, second computing device) independently generates Y; (2) implementations in which all processors in the set of one or more processors (e.g., all in the same device, or distributed among multiple devices) contribute to the generation of both X and Y; and (3) other variations.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs through the principles described herein. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

What is claimed is:

1. A method comprising:
obtaining, by one or more processors, a source video;
identifying, by the one or more processors, a plurality of video segments in the source video, wherein each video segment of the plurality of video segments includes a respective plurality of consecutive frames;
obtaining, by the one or more processors, a plurality of frame subsets, wherein each frame subset of the plurality of frame subsets consists of a subset of frames within a different one of the plurality of video segments;
generating, by a generative artificial intelligence (AI) model, a plurality of new video segments each corresponding to a different one of the plurality of frame subsets, at least in part by providing the plurality of frame subsets as inputs to the generative AI model; and
generating, by the one or more processors, a new video that includes the plurality of new video segments.

2. The method of claim 1, wherein the generative AI model includes a multimodal large language model (MLLM), and wherein providing the plurality of frame subsets as inputs to the generative AI model includes providing the plurality of frame subsets as successive prompts to the MLLM.

3. The method of claim 1, wherein each frame subset of the plurality of frame subsets is a single frame of the respective video segment of the plurality of video segments.

4. The method of claim 1, wherein the new video includes the plurality of new video segments and one or more video segments from the source video.

5. The method of claim 1, wherein each new video segment of the plurality of new video segments includes the different one of the plurality of frame subsets.

6. The method of claim 1, wherein obtaining the plurality of frame subsets includes selecting the plurality of frame subsets using a machine learning model.

7. The method of claim 6, wherein the machine learning model is trained to predict a quality metric for each input frame subset.

8. The method of claim 1, wherein identifying the plurality of video segments in the source video includes segmenting the source video into segments of a predetermined length.

9. The method of claim 1, wherein identifying the plurality of video segments in the source video includes detecting scene transitions in the source video.

10. A system comprising:
one or more processors; and
one or more memories storing instructions that, when executed by the one or more processors, cause the one or more processors to perform operations comprising:
obtaining a source video;
identifying a plurality of video segments in the source video, wherein each video segment of the plurality of video segments includes a respective plurality of consecutive frames;
obtaining a plurality of frame subsets, wherein each frame subset of the plurality of frame subsets consists of a subset of frames within a different one of the plurality of video segments;
generating, by a generative artificial intelligence (AI) model, a plurality of new video segments each corresponding to a different one of the plurality of frame subsets, at least in part by providing the plurality of frame subsets as inputs to the generative AI model; and
generating a new video that includes the plurality of new video segments.

11. The system of claim 10, wherein the generative AI model includes a multimodal large language model (MLLM), and wherein providing the plurality of frame subsets as inputs to the generative AI model includes providing the plurality of frame subsets as successive prompts to the MLLM.

12. The system of claim 10, wherein each frame subset of the plurality of frame subsets is a single frame of the respective video segment of the plurality of video segments.

13. The system of claim 10, wherein the new video includes the plurality of new video segments and one or more video segments from the source video.

14. The system of claim 10, wherein each new video segment of the plurality of new video segments includes the different one of the plurality of frame subsets.

15. The system of claim 10, wherein obtaining the plurality of frame subsets includes selecting the plurality of frame subsets using a machine learning model.

16. One or more non-transitory, computer-readable media storing instructions that, when executed by one or more processors, cause the one or more processors to perform operations comprising:
obtaining a source video;
identifying a plurality of video segments in the source video, wherein each video segment of the plurality of video segments includes a respective plurality of consecutive frames;
obtaining a plurality of frame subsets, wherein each frame subset of the plurality of frame subsets consists of a subset of frames within a different one of the plurality of video segments;
generating, by a generative artificial intelligence (AI) model, a plurality of new video segments each corresponding to a different one of the plurality of frame subsets, at least in part by providing the plurality of frame subsets as inputs to the generative AI model; and
generating a new video that includes the plurality of new video segments.

17. The one or more non-transitory, computer-readable media of claim 16, wherein the generative AI model includes a multimodal large language model (MLLM), and wherein providing the plurality of frame subsets as inputs to the generative AI model includes providing the plurality of frame subsets as successive prompts to the MLLM.

18. The one or more non-transitory, computer-readable media of claim 16, wherein each frame subset of the plurality of frame subsets is a single frame of the respective video segment of the plurality of video segments.

19. The one or more non-transitory, computer-readable media of claim 16, wherein the new video includes the plurality of new video segments and one or more video segments from the source video.

20. The one or more non-transitory, computer-readable media of claim 16, wherein each new video segment of the plurality of new video segments includes the different one of the plurality of frame subsets.
